(19) United States
(12) Patent Application Publication
(10) Pub. No.: US 2004/0138861 A1
(43) Pub. Date: Jul. 15, 2004

(54) Configuration model producing apparatus

(75) Inventors: Makoto Onodera, Tsuchiura (JP); Yoshimitsu Hiro, Yokohama (JP)

Correspondence Address: McDermott, Will & Emery, 600, 13th Street, N.W., Washington, DC, 20005-3096, US

(73) Assignee: HITACHI, LTD.

(21) Appl. No.: 10/630,801

(22) Filed: Jul. 31, 2003

(30) Foreign Application Priority Data
Jan. 9, 2003 (JP) 2003-003277

(51) Int. Cl. G06F 17/10

(52) U.S. Cl. 703/2

(57) ABSTRACT

In a configuration model producing apparatus, a simplification candidate portion automatic extracting means produces a configuration by expanding the configuration model into an outside by a reference parameter, and also a configuration by reducing the configuration model into an inside by the reference parameter. The expanded configuration and the reduced configuration are compared wit the configuration model, respectively, thereby extracting partial configurations, which disappear and are reversed therefrom. Removing the partial configuration coincident with a predetermined condition among the configurations, an analytical configuration model is produced, being necessary for use in analyzing.

### BACKGROUND OF THE INVENTION

The present invention relates to a CAE (Computer Aided Engineering) system for numerically simulating physical phenomena through the numerical analysis by using a computer therein, and it relates to, in particular, a configuration model producing apparatus for producing the configuration model to be used in analyzing, being simplified on portions unnecessary for analyzing thereon, upon basis of the configuration model produced by a three(3)-dimensional (3D) modeler.

As the representative methods for simplifying the configuration model, in particular, on portions unnecessary for analyzing thereon, there are known the following two (2) methods. Namely, according to a first one, as is described, for example, in Japanese Patent Laying-Open No. Hei 06-259505 (1994) <JP-A 06-259505>, the configuration of a part is extracted from the configuration data, when a user indicates the simplification by a kind thereof and a configuration element of a target, which is in parallel to the configuration element and falls within either one of the connection conditions, such as, of being concave, convex, or smoothed, for example. And then, the partial configuration extracted is removed, thereby producing a simplified model.

According to the other method, as is described in, for example, in Japanese Patent Laying-Open No. Hei 2000-331194 (2000) <JP-A 2000-331194>, a size parameter, an area parameter, and a volume parameter are inputted, as the attributes of a target of simplification, for comparison to the attributes of the configuration model, such as, the size data, the area data and the volume data, for example. And, search is made on the attribute having the data being smaller than the parameter inputted, to remove the attribute therefrom, and producing the simplified model.

However, with the method described in the Japanese Patent Laying-Open No. Hei 06-259505 (1994) mentioned above, it is necessary to select the portions to be simplified one by one in a manner of dialog, and therefore it is impossible to designate the configuration elements in a plural number thereof, at the same time, collectively. For this reason, the number of steps for simplification increases as the configuration model comes to be complicated. Also, with the method described in the Japanese Patent Laying-Open No. Hei 2000-331194 (2000), simplification on the configuration can be achieved only by a unit of the attribute when simplifying the configuration while removing the attribute therefrom. Also, for the configuration model, which is obtained by converting the configuration model data between the different 3D configuration models, and/or the configuration models, which are inputted through the configuration model data internal file, such as, IGES (Initial Graphics Exchange Specification), Parasolid, etc., it is impossible to simplify the configuration since no information is remained about the attribute thereof. Further, the information of the attribute depends on the process of producing the configuration model by mean of the 3D configuration modeler. Thus, depending on the processes of producing the configuration model, sometimes there is produced a partial configuration, on which the simplification cannot be made.

### BRIEF SUMMARY OF THE INVENTION

An object, according to the present invention, is to achieve an effective simplification, on a partial configuration being unnecessary for the analysis, in particular, on the configuration model of a target of analysis.

For achieving the object mentioned above, according to the present invention, there is provided a configuration model producing apparatus, for producing an analytical configuration model, being simplified on partial configurations unnecessary for analyzing, upon basis of the configuration model, comprising: a configuration model data inputting means for inputting the configuration model; a reference parameter designating means for inputting reference parameter for comparing partial configurations and sizes to partial configurations of the configuration model; a simplification candidate portion automatic extracting means for automatically searching the partial configuration falling within a region of the reference parameter, and for extracting the partial configuration coincident with the searching to be a simplification candidate partial configuration; a simplification portion selecting means for selecting the partial configuration to be simplified from the simplification candidate partial configuration; and a simplifying means for producing the analytical configuration model removing the selected partial configuration therefrom.

Also, according to the present invention, there is further provided a configuration model producing apparatus, for producing an analytical configuration model, being simplified on partial configurations unnecessary for analyzing, upon basis of the configuration model, comprising: a configuration model data inputting means for inputting the configuration model; a reference parameter designating means for inputting reference parameter for comparing partial configurations and sizes to partial configurations of the configuration model; a simplification database registering means for registering data of the partial configuration to be simplified into a simplification database, together with a simplification name thereof; a simplification parameter selecting means for outputting data of the partial configuration, which is read therein from the simplification database with designating a target to be simplified, as a reference parameter; a simplification candidate portion automatic extracting means for automatically searching the partial configuration falling within a region of the reference parameter, and for extracting the partial configuration coincident with the searching to be a simplification candidate partial configuration; a simplification portion selecting means for selecting the partial configuration to be simplified from the simplification candidate partial configuration; and a simplifying means for producing the analytical configuration model removing the selected partial configuration therefrom.

And, according to the present invention, preferably, in the configuration model producing apparatus, as described in the above, wherein said simplification candidate portion automatic extracting means, includes: means for producing a configuration, expanding from the configuration model in an outside direction thereof by the reference parameter, comparing the expanded configuration with the configuration model and searching the partial configuration disappearing and the partial configuration reversed, thereby registering the partial configuration, being coincident with the searching condition, to be a simplification candidate partial configuration; and means for producing a configuration, reducing from the configuration model in an inside direction thereof by the reference parameter, comparing the reduced configuration with the configuration model and searching the partial configuration disappearing and the partial configuration reversed, thereby registering the partial configuration, being coincident with the searching condition, to be the simplification candidate partial configuration.

And, according to the present invention, it is preferable that the configuration model producing apparatus, as described in the above, further comprises a simplification candidate portion emphatic displaying means for displaying the simplification candidate partial configuration, which is extracted by said simplification candidate automatic extracting means, with emphasizing thereon.

### BRIEF DESCRIPTION OF THE SEVERAL VIEWS OF THE DRAWING

FIG. 1 is a block-diagram of a configuration model producing apparatus, according to the present invention; and FIGS. 2 to 15 are views for explaining each portion, which the configuration model producing apparatus has, and in particular;

FIG. 2 is a view for showing the screen structure of a reference parameter designating means;

FIG. 3 is a view for showing the data structure of a reference parameter data;

FIG. 4 is a view for showing the screen structure of a simplification database registering means;

FIG. 5 is a view for showing the data structure of a simplification database;

FIG. 6 is a view for showing the screen structure of a simplification parameter selecting means;

FIG. 7 is a flowchart for showing the processing steps of a simplification candidate portion automatic extracting means;

FIG. 8 is a view for explaining the method for searching and extracting the candidate portion to be simplified;

FIG. 9 is a view for explaining the processing in a simplification candidate portion emphatic displaying means and a simplification candidate portion selecting means;

FIG. 10 is a view for showing a simplification candidate partial configuration data, and the data structure of the simplification candidate partial configuration data;

FIG. 11 is a flowchart for showing the steps of processing simplification in a simplifying means;

FIG. 12 is a view of a configuration model of a connecting rod, as a part to be simplified;

FIG. 13 is a view for showing a simplification database;

FIG. 14 is a view for showing a simplify button; and

FIG. 15 is a view of the configuration model for use in analysis, which is obtained by simplifying the configuration model shown in FIG. 12.

### DETAILED DESCRIPTION OF THE INVENTION

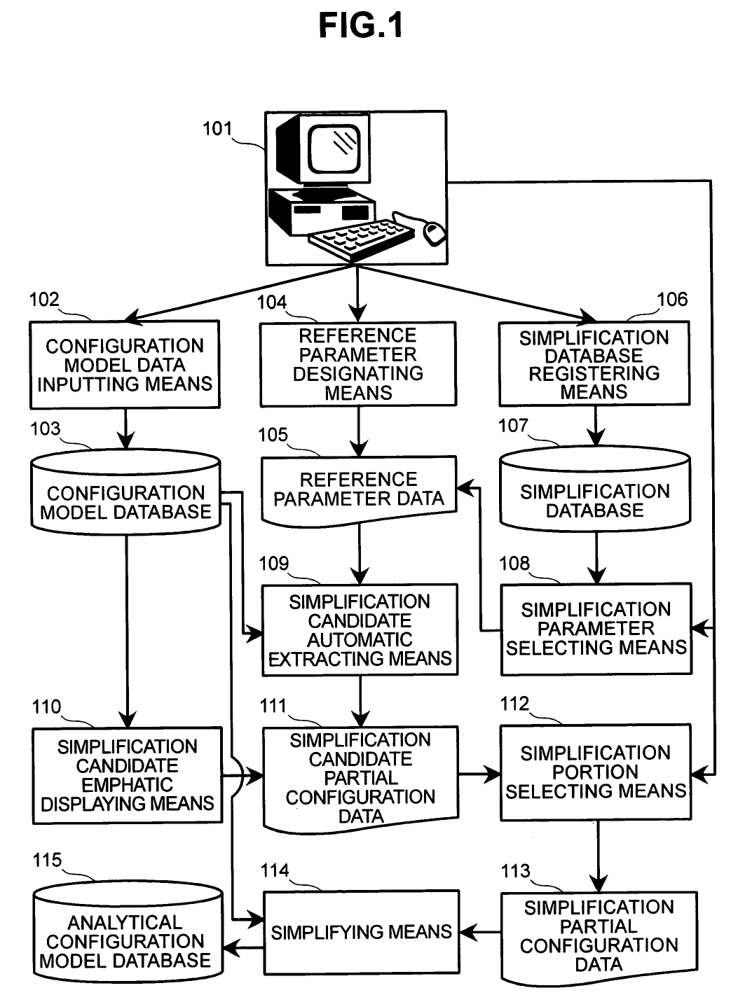

Hereinafter, explanation will be given on a configuration model producing apparatus of one embodiment, according to the present invention. Herein, FIG. 1 is the block-diagram of the configuration model producing apparatus, according to the present invention. The configuration model producing apparatus comprises an input/output device 101, a configuration model data inputting means 102, a configuration model database 103, a reference parameter designating means 104, a reference parameter data 105, a simplification database registering means 106, a simplification database 107, a simplification parameter selecting means 108, a simplification candidate portion automatic selecting means 109, a simplification candidate portion emphatic displaying means 110, a simplification candidate partial configuration data 111, a simplification candidate portion selecting means 112, a simplification candidate partial configuration data 113, a simplifying means 114, and an analytical configuration model database 115.

The input/output device 101 includes, a keyboard, a pointing device, a display, etc., for a system user to input and display data therethrough. The configuration model inputting means 102 inputs a configuration model therein, and registers it into the configuration model database 103. The reference parameter designating means 104 inputs a reference parameter to be used as a reference for simplification therein, and registers it as to be the reference parameter database 105. The simplification database registering means 106 registers the simplification parameter into the simplification database 107, for each target of analyzing. The simplification parameter database 108 selects a simplification parameter from the simplification database 107, and registers it into the reference parameter data 105.

The simplification candidate portion automatic selecting means 109 produces a configuration, which is expanded into an outside direction of the configuration model by a reference parameter, and also a configuration, which is reduced into an inside direction of the configuration model by the reference parameter 106, for the configuration model data, and compares between the expanded configuration and the configuration model, as well as., between the reduced configuration and the configuration model, thereby to make search on a partial configuration which disappears or is reversed therefrom. Then, it registers the partial configuration, which is coincident with the search condition, as to be a simplification candidate partial configuration data 111 therein.

The simplification candidate portion emphatic displaying means 110 displays the partial configuration, which is registered in the simplification candidate partial configuration data 111, with making emphasis thereon. The simplification candidate portion selecting means 112 selects a partial configuration to be simplified, from the simplification candidate portion being displayed while being emphasized thereon, and registers the selected simplification candidate portion into the simplification partial configuration data 113. The simplifying means 114 registers the configuration model for use in analyzing, which is produced by removing the partial configuration registered in the simplification partial configuration data 113, into the analytical configuration model database 115.

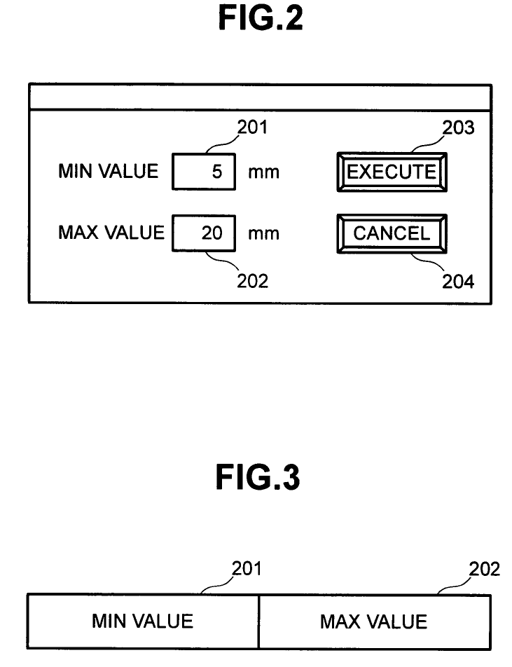

FIG. 2 shows an example of the screen structure of the reference parameter designating means 104. The user using the configuration model producing apparatus inputs the minimum value 201 and the maximum value 202 of the configuration to be simplified, as reference parameters on an operation screen shown in FIG. 2, with using the input/output device 101. At the time when an execute button 203 is pushed down, numerical data inputted in the minimum value 201 and the maximum value 202 are registered as the minimum value 201 and the maximum value 202 of the reference parameter data 105. When retrying, a cancel button 204 is pushed down. In a case where no data is inputted as the minimum value data, zero (0) is registered.

FIG. 3 shows an example of the data structure of the reference parameter data 105. In this reference parameter data 105 are registered the minimum value 201 and the maximum value 202 of the partial configuration to be simplified.

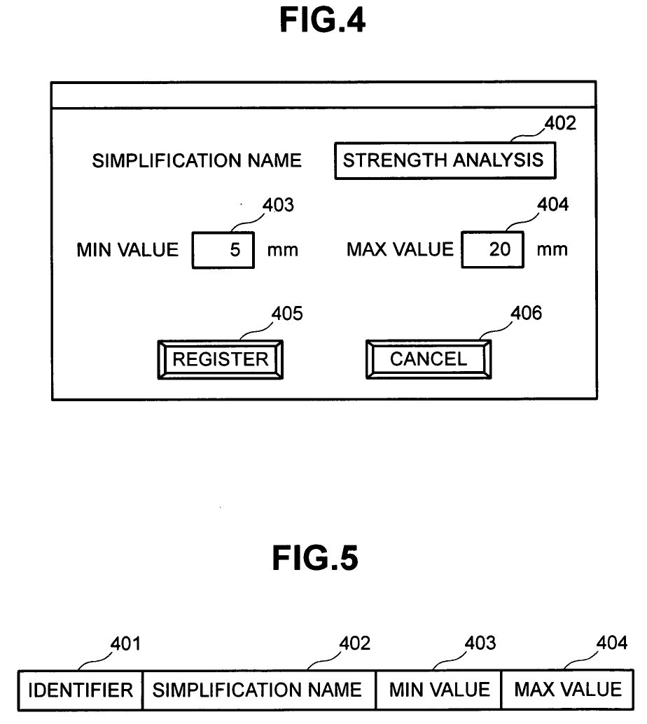

FIG. 4 shows an example of the screen structure of the simplification database registering means 106. The user of the configuration model producing apparatus inputs a simplification name to be registered into the simplification database 107, and a minimum value 403 and a maximum value 404 of the partial configuration to be simplified, on the operation screen shown in FIG. 4 with using the input/output device 101. At the time when a register button 405 is pushed down, the data inputted into the simplification name 402, the minimum value 403 and the maximum value 404 are registered into the simplification name 402, the minimum value 403 and the maximum value 404, respectively. If no data is inputted as the minimum value, the zero (0) is registered therein. When retrying, a cancel button 406 is pushed down.

FIG. 5 shows an example of the data structure of the simplification database 107. Into the simplification database 107 are registered an identifier 401 of a kind of simplification, as well as, the simplification name 402, and the minimum value 403 and the maximum value 404 of the partial configuration to be simplified. In the case of the reference parameter designating means 104 shown in FIG. 2, the inputted minimum value 201 and the maximum value 202 are only registered as to be the reference parameter data 105, temporarily. On the contrary, in the case of FIGS. 4 and 5, the inputted minimum value 403 and the maximum value 404 are registered into the simplification database 107, by referring to the simplification name. Accordingly, experiments of the user of the present apparatus and also know-how of a veteran can be accumulated therein, and then the apparatus can be used, easily.

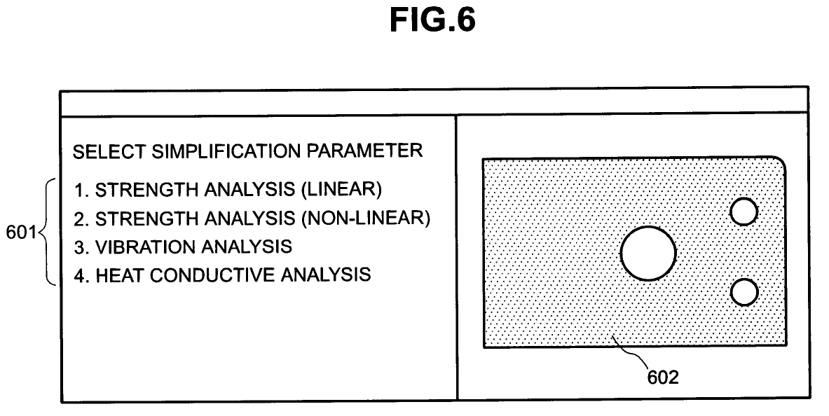

FIG. 6 shows an example of the screen, which is displayed by means of the simplification parameter selecting means 108. The simplification parameter selecting means 108 reads therein the data from the simplification database 107, and displays a list 601 of the simplification names. At the same time, the configuration model 602 is displayed in the right-hand side on the screen. The user designates a simplification target from the list 601 of simplification names, with using the input/output device 101. The simplification parameter selecting means 108 reads therein the minimum value 403 and the maximum value 404 corresponding to the simplification name 402 from the simplification database 107, and it registers them to be the minimum value 201 and the maximum value 202 of the reference parameter data 105.

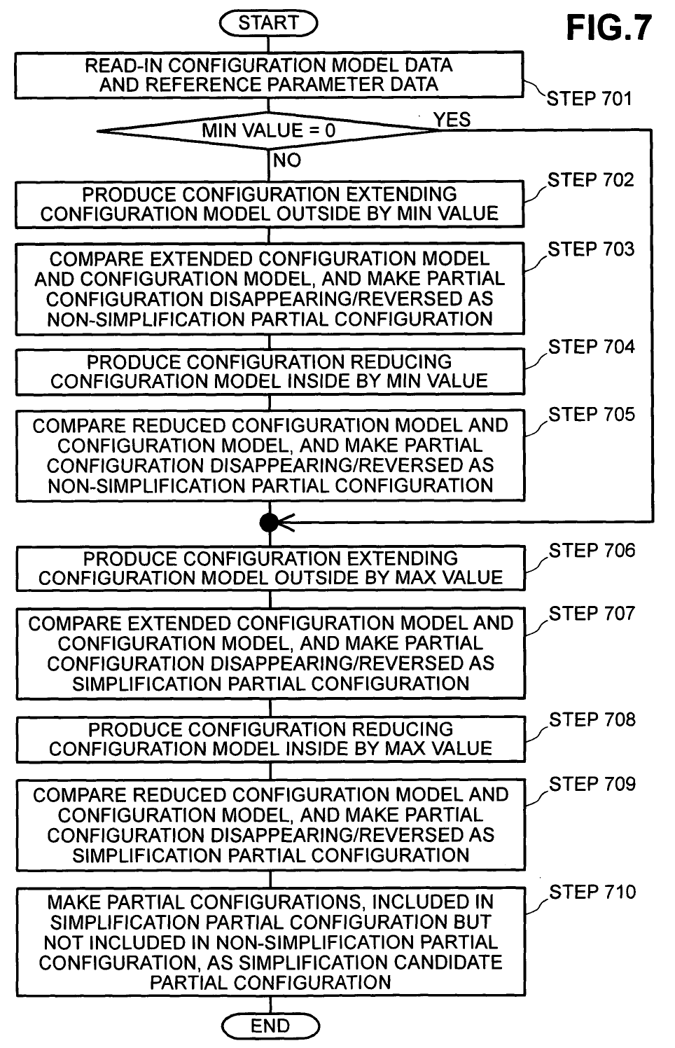

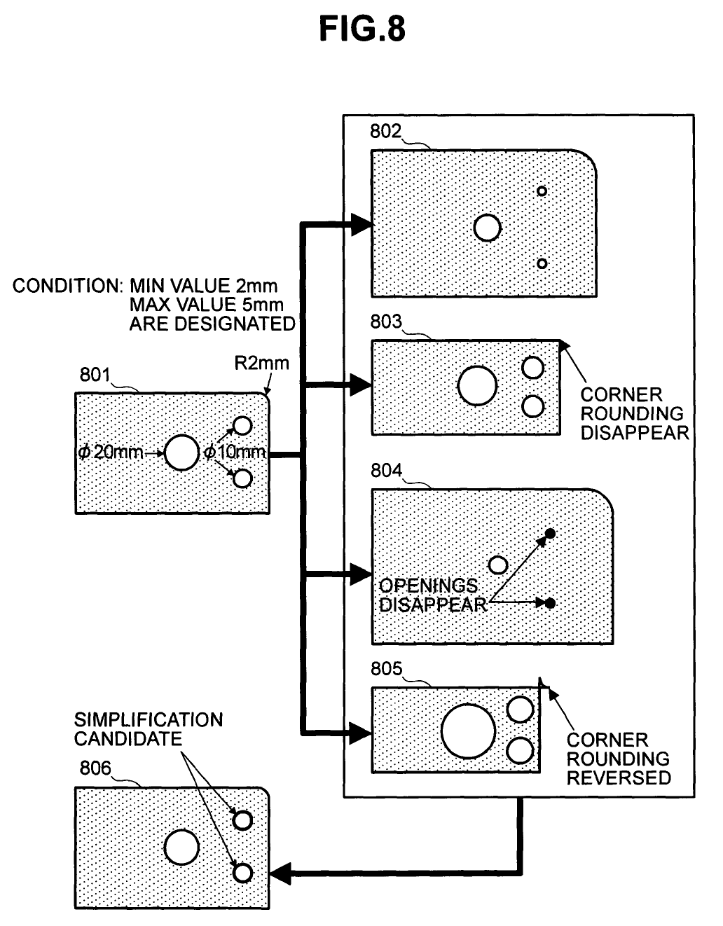

FIG. 7 shows an example of steps for processing in the simplification candidate portion automatic extracting means 109. FIG. 8 shows an example of a method for searching and extracting the simplification candidate portion.

STEP 701: The configuration data is read therein, from the configuration model database 103, and also the reference parameter data 105 (801).

STEP 702: A configuration is produced, which can be obtained by expanding the configuration model into an outside direction of the configuration model by the numerical value registered in the minimum value 201 of the reference parameter data 105 (802).

STEP 703: The expanded configuration and the configuration model are compared with, so as to find out partial configurations which disappear and are reversed therefrom, and those configuration are made to be non-simplification partial configuration.

STEP 704: A configuration is produced, which can be obtained by reducing the configuration model into an inside direction of the configuration model by the numerical value registered in the minimum value 201 of the reference parameter data 105 (803).

STEP 705: The reduced configuration and the configuration model are compared with, so as to find out partial configurations which disappear and are reversed therefrom, and those configuration are made to be non-simplification partial configuration.

STEP 706: A configuration is produced, which can be obtained by expanding the configuration model into the outside direction of the configuration model by the numerical value registered in the maximum value 202 of the reference parameter data 105 (804).

STEP 707: The expanded configuration and the configuration model are compared with, so as to find out partial configurations which disappear and are reversed therefrom, and those configuration are made to be simplification partial configuration.

STEP 708: A configuration is produced, which can obtained by reducing the configuration model into the inside direction of the configuration model by the numerical value registered in the maximum value 202 of the reference parameter data 105 (805).

STEP 709: The reduced configuration and the configuration model are compared with, so as to find out partial configurations which disappear and are reversed therefrom, and those configuration are made to be simplification partial configuration.

STEP 710: The partial configuration, which is included in the simplification partial portion but not in the non-simplification partial configuration, is registered into the simplification candidate partial configuration data 111 (806).

In a case where zero (0) is registered as to be the minimum value 201 of the reference parameter data 105, the steps 702 to 705 are omitted.

With the steps mentioned above, the simplification candidate portion(s) can be extracted, automatically. For the user of the configuration model producing apparatus to grasp the relationship clearly, between the reference parameter designated and the simplification candidate portion to be searched, an abstract of the steps of this processing is described in an operation manual.

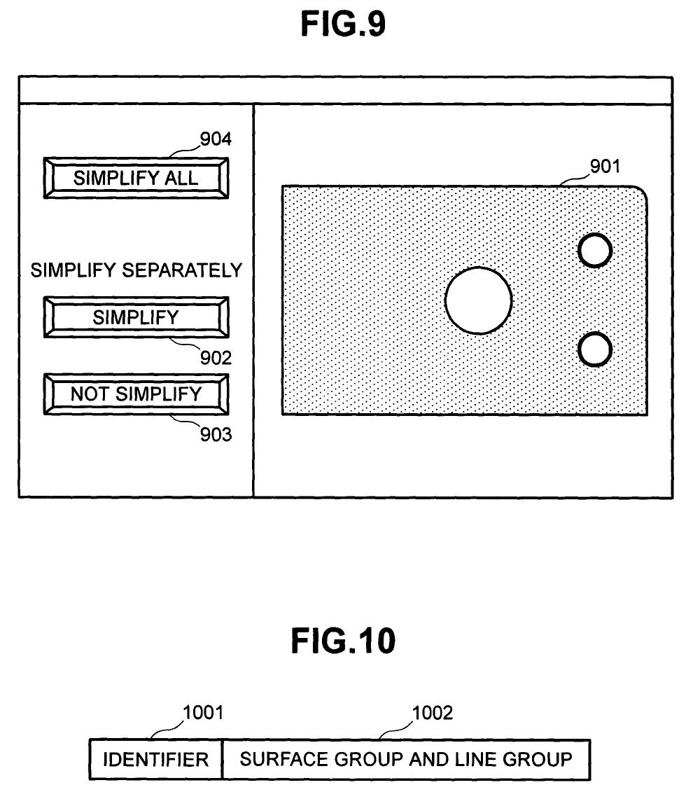

FIG. 9 shows the screen, on which the simplification candidate is displayed with making emphasis thereon, and on the right-hand side in the figure is shown a configuration model 901 being displayed with making emphasis thereon by the function of the simplification candidate emphatic displaying means 110, while in the left-hand side buttons 902 to 904, which are necessary for simplification, being displayed by the function of the simplification portion selecting means 112. FIG. 10 is examples of the simplification candidate partial configuration data 111, a simplification partial configuration data 113, and in particular, in the case when an identifier 1001 of the simplification configuration is registered in the simplification candidate partial configuration data 111, and data 1002 of a group of surfaces and a group of lines to be targets of simplification in the simplification partial configuration data 113.

The simplification candidate portion emphatic displaying means 110 displays the group of surfaces and the group of lines, which are registered in data 1002 of the group of surfaces and the group of lines to be the targets of simplification, with making emphasis thereon, selecting among the simplification candidate partial configuration data 111. The emphatic displaying means that the group of surfaces and the group of lines are displayed being expanded or changed in the color thereof on the input/output device 101. In FIG. 9, two (2) openings in a FIG. 901 are displayed with making emphasis thereon. The emphatic displaying is means for allowing the user to see the group of surfaces and the group of lines of the target portions of simplification, easily, and therefore it should not be limited on to this method, as far as it is a method for enabling the target portion of simplification to be distinct from that portion not to be simplified, for the simplifying means 114 which will be mentioned later.

The simplification portion selecting means 112 prompts to ascertaining necessity/non-necessity of simplification, for each the group of surfaces and the group of lines, which are relating to the identifier 1001 of the simplification configuration. When a “simplify” button 902 in FIG. 9 is selected for simplifying individually or separately, data of the identifier 1001 and the group of surfaces and the group of lines 1002 are registered into the simplification partial configuration data 113. On the other hand, if a “simplify all” button 904, all of the data registered in the simplification candidate partial configuration data 111 are registered in the simplification partial configuration data 113, but skipping the simplification portion selecting process. When a “not simplify” button 903 is selected, the simplification is stopped, and it turns back to the process being previous by one step.

FIG. 11 shows an example of steps for simplifying processing in the simplifying means 114.

STEP 1101: The simplifying means 114 reads therein the simplification partial configuration data 113.

STEP 1102: The simplifying means 114 removes the group of surfaces and the group of lines therefrom, which are registered in the group of surfaces and the group of lines 1002 of the simplification partial configuration data 113.

STEP 1103: The simplifying means 113 elongates the surfaces and the lines neighboring to each other, in a tangential direction thereof, so that they come across with each other, upon basis of each the surface and the line removed.

STEP 1104: The simplifying means 114 cuts off the portions extending over the crossing part between the surfaces, and also on the lines.

The simplification candidate portion automatic extracting means 109 produces the configurations, which are obtained by expanding the configuration model into an outside direction by the reference parameter and by reducing the configuration model into an inside direction by the reference parameter, respectively, for the configuration model parameter. Then, the expanded configurations and the reduced configuration produced are compared with the configuration model, respectively. Search is made on the partial configuration(s) disappearing from the configuration model and the partial configuration(s) reversed therefrom. The partial configuration(s) coincident with the search condition is/are registered as to be the simplification candidate partial configuration data 111. Thus, the configuration, which is not necessary for analysis can be extracted, automatically, only by inputting the reference parameter 105 for simplification, or only by selecting the simplification data from the simplification database 107, even for the configuration model having no attribute information thereof. Accordingly, it is possible to produce the configuration model for use in analyzing, with high efficiency.

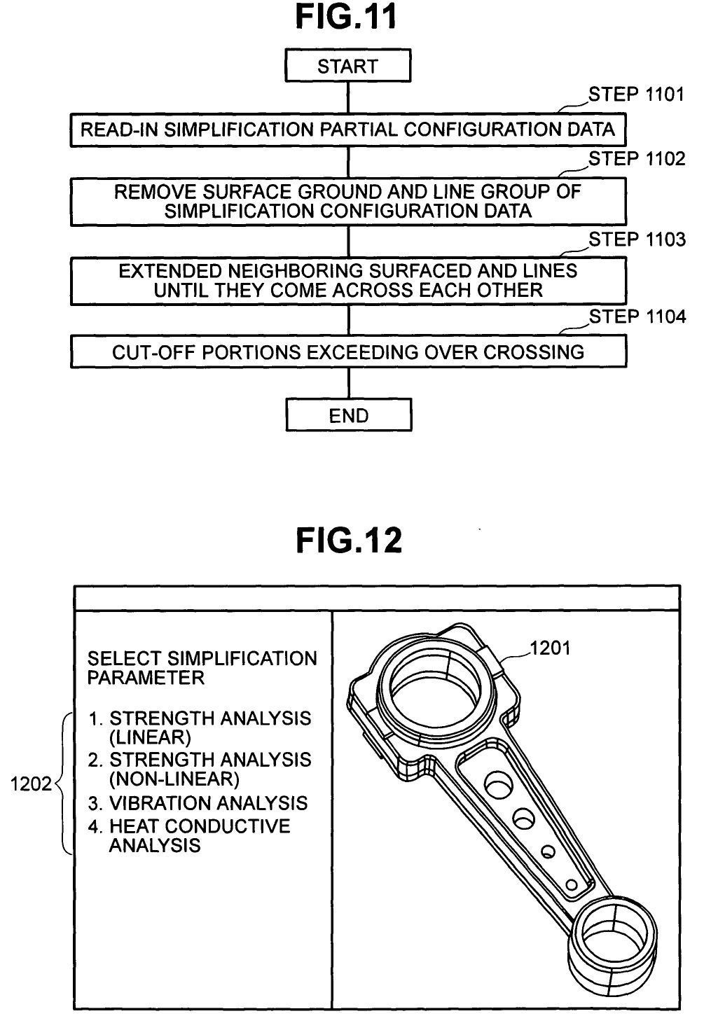

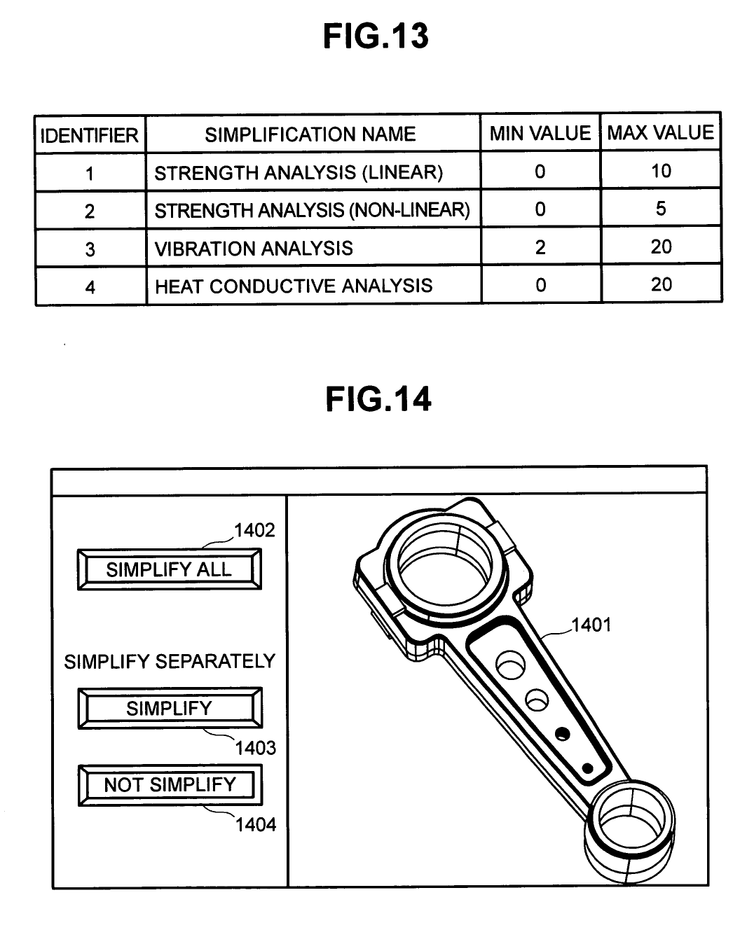

As a concrete example of producing the simplified configuration mode is explained about a case, where the simplification is made on the configuration model of a part, such as a connecting rod, for example. FIG. 12 shows the configuration model 1201 of the part, i.e., the connecting rod. The configuration model 1201 presents the production configuration, strictly and closely, and therefore it includes a rounding and an opening in a large number thereof, which gives no ill influence on accuracy in analyzing thereof. Then, in the actual analyzing, the numerical analysis is executed by simplifying the configuration thereof. A column 1202 on the left-hand side in FIG. 12 shows a column for showing a list of the simplification data, which is registered in the simplification database 107. The details of the simplification data 107 are shown in FIG. 13. In this figure, four (4) kinds of simplification data are registered. The user designates the simplification data at her/his desire from the columns 1202 of the simplification database 107. In the present embodiment, “Strength Analysis (Linear)” is selected, which is represented by an identifier 1. With this selection, the screen moves to a screen for simplification.

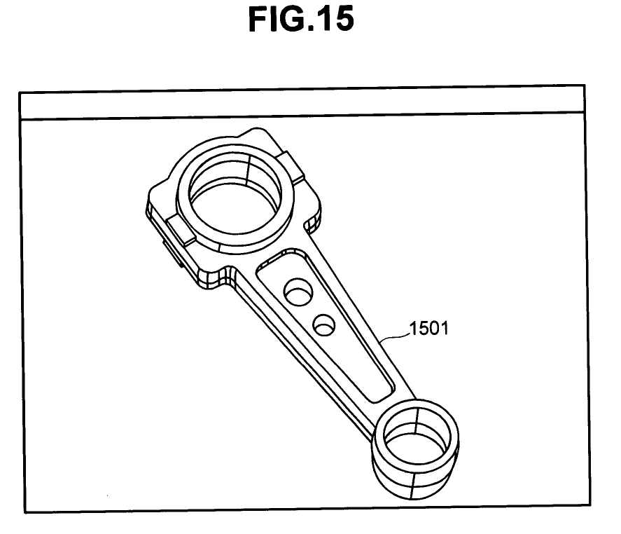

FIG. 14 shows an example of the screen, on which are displayed a configuration model 1401 being displayed with emphasizing on the simplification portion, and the bottoms 1402 to 1404 to be used for selection on the necessity of simplification and the method thereof. In the present embodiment, the “simplify all” button 1402 is pushed down. The simplified configuration model 1501 obtained after this operation is shown in FIG. 15 the small openings located on the configuration model 1201 before executing the simplification are omitted, on the configuration model 1501 through the simplification processing. The configuration model 1501 is used to be the configuration model for use in analyzing. The user can produce the simplified configuration model for use in analyzing, with high reliability, even for the configuration model having no attribute information thereof, only by inputting the reference parameter 105 for simplification, or by selecting the simplification data registered in the simplification database 107.

What is claim d is:

1. A configuration model producing apparatus, for producing an analytical configuration model from a configuration model modeling an outer configuration of a target of analyzing, comprising:
a simplification candidate portion automatic extracting means for taking out a difference from an original configuration model by expanding or reducing the configuration model partially, thereby deciding to be a candidate to be removed if the difference is less than a predetermined reference; and
a simplifying means for producing the configuration model for use in analyzing, by removing the candidate decided to be removed from.

2. A configuration model producing apparatus, for producing an analytical configuration model, being simplified on partial configurations unnecessary for analyzing, upon basis of the configuration model, comprising:
a configuration model data inputting means for inputting the configuration model;
a reference parameter designating means for inputting reference parameter for comparing partial configurations and sizes to partial configurations of the configuration model;
a simplification candidate portion automatic extracting means for automatically searching the partial configuration falling within a region of the reference parameter, and for extracting the partial configuration coincident with the searching to be a simplification candidate partial configuration;
a simplification portion selecting means for selecting the partial configuration to be simplified from the simplification candidate partial configuration; and
a simplifying means for producing the analytical configuration model removing the selected partial configuration therefrom.

3. The configuration model producing apparatus, as described in the claim 2, wherein said simplification candidate portion automatic extracting means, includes: means for producing a configuration, expanding from the configuration model in an outside direction thereof by the reference parameter, comparing the expanded configuration with the configuration model and searching the partial configuration disappearing and the partial configuration reversed, thereby registering the partial configuration, being coincident with the searching condition, to be a simplification candidate partial configuration; and means for producing a configuration, reducing from the configuration model in an inside direction thereof by the reference parameter, comparing the reduced configuration with the configuration model and searching the partial configuration disappearing and the partial configuration reversed, thereby registering the partial configuration, being coincident with the searching condition, to be the simplification candidate partial configuration.

4. The configuration model producing apparatus, as described in the claim 2, further comprising a simplification candidate portion emphatic displaying means for displaying the simplification candidate partial configuration, which is extracted by said simplification candidate automatic extracting means, with emphasizing thereon.

5. The configuration model producing apparatus, as described in the claim 3, further comprising a simplification candidate portion emphatic displaying means for displaying the simplification candidate partial configuration, which is extracted by said simplification candidate automatic extracting means, with emphasizing thereon.

6. A configuration model producing apparatus, for producing an analytical configuration model, being simplified on partial configurations unnecessary for analyzing, upon basis of the configuration model, comprising:
a configuration model data inputting means for inputting the configuration model;
a reference parameter designating means for inputting reference parameter for comparing partial configurations and sizes to partial configurations of the configuration model;
a simplification data base registering means for registering data of the partial configuration to be simplified into a simplification database, together with a simplification name thereof;
a simplification parameter selecting means for outputting data of the partial configuration, which is read therein from the simplification database with designating a target to be simplified, as a reference parameter;
a simplification candidate portion automatic extracting means for automatically searching the partial configuration falling within a region of the reference parameter, and for extracting the partial configuration coincident with the searching to be a simplification candidate partial configuration;
a simplification portion selecting means for selecting the partial configuration to be simplified from the simplification candidate partial configuration; and
a simplifying means for producing the analytical configuration model removing the selected partial configuration therefrom.

7. The configuration model producing apparatus, as described in the claim 6, wherein said simplification candidate portion automatic extracting means, includes: means for producing a configuration, expanding from the configuration model in an outside direction thereof by the reference parameter, comparing the expanded configuration with the configuration model and searching the partial configuration disappearing and the partial configuration reversed, thereby registering the partial configuration, being coincident with the searching condition, to be a simplification candidate partial configuration; and means for producing a configuration, reducing from the configuration model in an inside direction thereof by the reference parameter, comparing the reduced configuration with the configuration model and searching the partial configuration disappearing and the partial configuration reversed, thereby registering the partial configuration, being coincident with the searching condition, to be the simplification candidate partial configuration.

8. The configuration model producing apparatus, as described in the claim 6, further comprising a simplification candidate portion emphatic displaying means for displaying the simplification candidate partial configuration, which is extracted by said simplification candidate automatic extracting means, with emphasizing thereon.

9. The configuration model producing apparatus, as described in the claim 7, further comprising a simplification candidate portion emphatic displaying means for displaying the simplification candidate partial configuration, which is extracted by said simplification candidate automatic extracting means, with emphasizing thereon.
